(19) United States
(12) Patent Application Publication
(10) Pub. No.: US 2025/0214480 A1
(43) Pub. Date: Jul. 3, 2025

(54) MONITORING APPARATUS, MONITORING METHOD AND PROGRAM

(71) Applicant: NIPPON TELEGRAPH AND TELEPHONE CORPORATION, Tokyo (JP)

(72) Inventors: Yukio NAGAFUCHI, Tokyo (JP); Hiroki NAGAYAMA, Tokyo (JP); Asami MIYAJIMA, Tokyo (JP)

(21) Appl. No.: 18/850,242

(22) PCT Filed: Mar. 31, 2022
(86) PCT No.: PCT/JP2022/016782

§ 371 Date: Sep. 24, 2024

(51) Int. Cl. B60L 55/00

(52) U.S. Cl. CPC B60L 55/00

(57) ABSTRACT

A monitoring device according to an embodiment includes a collection part configured to collect predetermined information from each entity constituting an electric power supply and demand control service using an electric transportation device; an analysis part configured to detect occurrence of an abnormality in the entity through a predetermined analysis using the information collected using the collection part; and a handling part which performs control or notification to deal with the abnormality when the abnormality occurrence is detected.

### TECHNICAL FIELD

The present invention relates to a monitoring device, a monitoring method, and a program.

### BACKGROUND ART

In recent years, electric vehicles (EVs) have become more popular and it is expected that electric power supply and demand control services using EVs will become available in the future. Electricity supply and demand control using EVs is a system which supplies electricity stored in EVs to buildings and the like to achieve cuts in peaks in power. For example, NPLs 1 and 2 propose constructing a virtual power plant (VPP) using EVs.

### CITATION LIST

### Non Patent Literature

NPL 1: Junichi SHIRASU, Takashi MATSUMURA, Kota MAKIHARA, Eiji TOMIMURA, Mizue HARADA, Katsuharu EMURA, “Virtual Power Plant (VPP) System using EV/PHV”, SEI Technical Review No. 194, January 2019.
NPL 2: Takeshi ARAI, Shigemichi WATANABE, Yu MIYAZAKI, Noriaki KIKUCHI, Yuko INOUE, “Services being Undertaken by NTT Anode Energy”, NTT Technical Journal 2020.5.

### SUMMARY OF INVENTION

### Technical Problem

However, with regard to power supply and demand control using EVs, service continuity when any abnormality (for example, failure, impossible processing or operation request, cyber attack, and the like) occurs in the constituent elements thereof (for example, EVs, electric vehicle supply equipment (EVSE), buildings, and the like) is not considered. Such problems may similarly exist with respect to power supply and demand control which utilizes various electric transportation devices other than EVs (for example, electrically driven motorcycles, tractors, ships, and the like).

An embodiment of the present invention was made in view of the above points, and an object of an embodiment of the present invention is to ensure service continuity even when an abnormality occurs in a constituent element of an electric power supply and demand control service which utilizes an electric transportation device.

### Solution to Problem

In order to achieve the above object, a monitoring device according to an embodiment includes a collection part configured to collect predetermined information from each entity constituting an electric power supply and demand control service using an electric transportation device; an analysis part configured to detect occurrence of an abnormality in the entity through a predetermined analysis using the information collected using the collection part; and a handling part which performs control or notification to deal with the abnormality when the abnormality occurrence is detected.

### Advantageous Effects of Invention

Even when an abnormality occurs in the constituent elements of a power supply and demand control service which utilizes an electric transportation device, service continuity can be ensured.

### BRIEF DESCRIPTION OF DRAWINGS

FIG. 1 is a diagram illustrating an example of an overall configuration of a system including a monitoring device according to an embodiment.

FIG. 2 is a diagram illustrating an example of a hardware configuration of the monitoring device according to the embodiment.

FIG. 3 is a diagram illustrating an example of a functional configuration of the monitoring device according to the embodiment.

FIG. 4 is a flowchart for describing an example of a flow of monitoring processing according to the embodiment.

### DESCRIPTION OF EMBODIMENTS

An embodiment of the present invention will be described below. In the embodiment, a monitoring device 10 which can monitor for the presence or absence of the occurrence of abnormalities in constituent elements of power supply and demand control services which utilize EVs that are an example of an electric transportation device and ensure service continuity by dealing with an abnormality when the occurrence of an abnormality is detected will be explained.

Here, the power supply and demand control service is a service which provides a mechanism to supply power stored in EVs to power demand facilities such as buildings and achieve peak power cuts. Although there are various constituent elements of electricity supply and demand services in addition to EVs, in the following description, EVs, EVSEs, buildings (including residences, commercial facilities, and the like), power grids, EVSE reservation applications, and reservation management servers which constitute the EVSE reservation service are assumed. The EVSE reservation service is a service for EV users to reserve the use of EVSE. EV users can reserve EVSE from an EVSE reservation application (hereinafter abbreviated as “EVSE reservation application”) installed on a terminal such as a smartphone, and the reservation information is managed by a reservation management server. Note that, hereinafter, the constituent elements of the power supply and demand control service will be referred to as “entities”.

In addition, abnormalities include failure of the entity (for example, failure of EV or EVSE and the like), a request for processing or an operation which the entity cannot fulfill, cyber attack of some kind against the entity (for example, attack on EV or EVSE, EVSE reservation service, and the like).

Although the power supply and demand control service has not yet been realized and is still at the stage of demonstration experiments, it is assumed that the service will be as follows.

(1) Various pieces of information are collected from each EV (for example, remaining battery level, location information, future usage schedule, and the like).

(2) A power usage state (power consumption or the like for each time period) is collected from entities which require power (for example, buildings and the like).

(3) An EV to be dispatched to the building during the time period is determined on the basis of the remaining battery level, the location information, the future usage schedule, and the like of the EV and the power consumption of the building at a certain time in the future when power consumption is high.

(4) The electricity from the dispatched EVs will cover (all or part of) the electricity of the building. Thus, the amount of electric power in that time period is cut to a peak, and for example, a reduction in electricity charges and prevention of excessive investment in electric power equipment are realized.

Although the power supply and demand control service realized in (1) to (4) above is assumed in the following description, this is merely an example and it goes without saying that it is not limited to this. The embodiments which will be described below can be similarly applied to mechanisms and services which supply electricity stored in an EV to another entity and achieve peak cuts and cost reductions for that entity.

Also, an electric vehicle (EV) is an example of an electric transportation device and the embodiment is not limited to electric vehicles, and for example, it can be similarly applied to all types of electric transportation device such as motorcycles, tractors, ships, and the like which are driven using electricity.

### Overall Configuration of System Including Monitoring Device 10

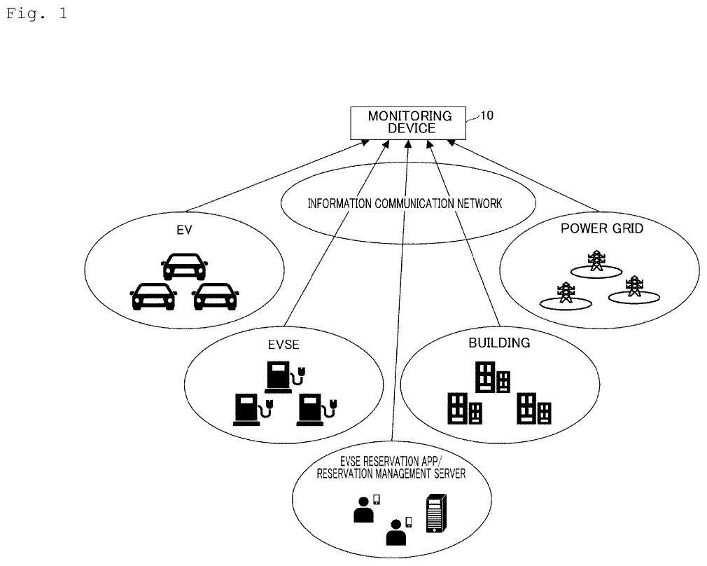

FIG. 1 shows an example of an overall configuration of a system including a monitoring device 10 according to the embodiment. As shown in FIG. 1, the monitoring device 10 is communicatively connected to each of entities such as an EV, EVSE, an EVSE reservation app, a reservation management server, a building (more precisely, building power management system), a power grid (more precisely, power grid power control system), and the like. Note that EVSEs can be installed not only in facilities such as charging stations, but also on the same premises as buildings and may be controlled by the power management system of the building.

The monitoring device 10 collects various information from each entity on a regular or irregular basis. Hereinafter, the information collected from each entity will be referred to as “collection information.” Also, the collection information collected from EVs will be referred to as “EV collection information,” the collection information collected from EVSE will be referred to as “EVSE collection information,” the collection information collected from an EVSE reservation application/reservation management server will be referred to as “reservation service collection information,” collection information collected from buildings will be referred to as “building collection information,” and the collection information collected from a power grid will be referred to as “power grid collection information.”

Various types of collection information can be considered and examples include the following information.

### (a) EV Collection Information

Identification information which uniquely identifies a vehicle (hereinafter referred to as vehicle ID)
Vehicle model
Remaining battery power (that is, the amount of remaining power stored in the EV)
Vehicle location information
State (for example, in use/vacant or the like)

### (b) EVSE Collection Information

Identification which uniquely identifies EVSE (hereinafter referred to as charger ID)
Usage state (amount of power supplied to EV and date and time thereof, amount of power received from EV and date and time thereof)
Location information indicating the EVSE installation location and the like
State (for example, power can be supplied/unable to supply, amount of power which can be supplied/time which can be supplied or the like)

### (c) Reservation Service Collection Information

Identification information which uniquely identifies a user (hereinafter referred to as user ID)
Reserved EVSE charger ID
Vehicle ID of the EV to be charged at the reserved EVSE
Reservation date and time
Power supply amount/power supply time or the like

### (d) Building Collection Information

Identification information which uniquely identifies a building (hereinafter referred to as building ID)
Current power consumption
Required power consumption in the future (for example, prediction average power consumption for the next time period)
Peak power consumption
EVSE installation state

### (e) Power Grid Collection Information

Power distribution state (power distribution amount to EVSE or the like)
Power capacity.
State (for example, information when a part of the power grid is out of order)

However, the collection information listed above is an example and is not limited to this and various information which can be collected from each entity can be used as collection information.

### Example of Hardware Configuration of Monitoring Device 10

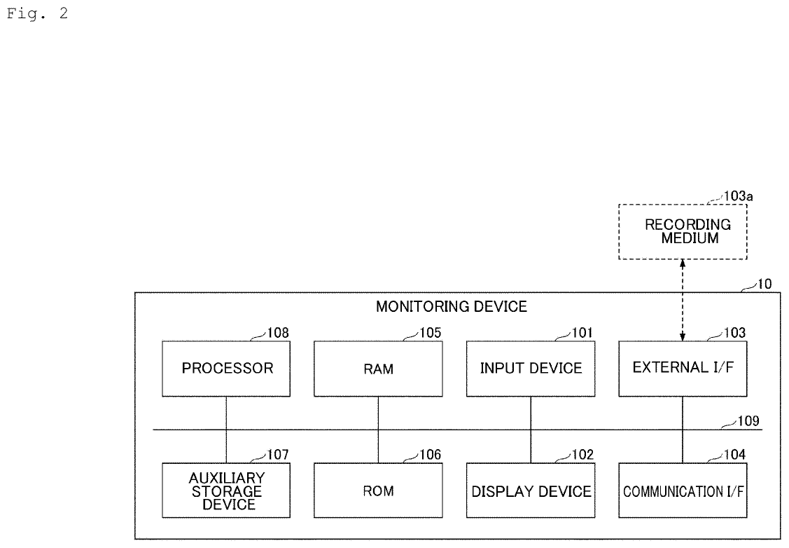

FIG. 2 shows an example of a hardware configuration of the monitoring device 10 according to the embodiment. As illustrated in FIG. 2, the monitoring device 10 according to the embodiment includes an input device 101, a display device 102, an external I/F 103, a communication I/F 104, a random access memory (RAM) 105, a read only memory (ROM) 106, an auxiliary storage device 107, and a processor 108. Each of these pieces of hardware is communicably connected via a bus 109.

The input device 101 is, for example, a keyboard, a mouse, a touch panel, a physical button, a switch, or the like. The display device 102 is, for example, a display, a display panel, or the like. Note that the monitoring device 10 may not include, for example, at least one of the input device 101 and the display device 102.

The external I/F 103 is an interface with external devices such as a recording medium 103a. The monitoring device 10 can read or write to the recording medium 103a via the external I/F 103. Note that examples of the recording medium 103a include a flexible disk, a compact disc (CD), a digital versatile disk (DVD), a secure digital (SD) memory card, and a universal serial bus (USB) memory card.

The communication I/F 104 is an interface through which the monitoring device 10 is connected to an information communication network. The RAM 105 is a volatile semiconductor memory (storage device) which temporarily holds programs and data. The ROM 106 is a nonvolatile semiconductor memory (storage device) which can retain programs and data even when the power is turned off. The auxiliary storage device 107 is, for example, a storage device such as a hard disk drive (HDD) or a solid state drive (SSD). The processor 108 is, for example, an arithmetic device such as a central processing unit (CPU) or a graphics processing unit (GPU).

The monitoring device 10 according to the embodiment has the hardware configuration shown in FIG. 2 so that it can implement various processes which will be described below. Note that the hardware configuration shown in FIG. 2 is an example and the hardware configuration of the monitoring device 10 is not limited to this. For example, the monitoring device 10 may include a plurality of auxiliary storage devices 107 and a plurality of processors 108 or may include various hardware other than the illustrated hardware.

### Example of Functional Configuration of Monitoring Device 10

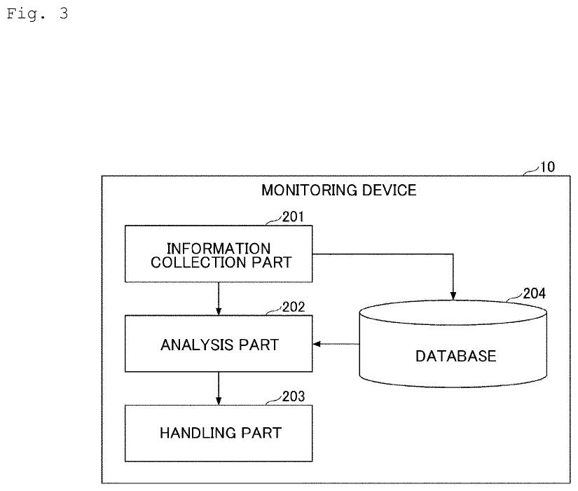

FIG. 3 shows an example of a functional configuration of the monitoring device 10 according to the embodiment. As shown in FIG. 3, the monitoring device 10 according to the embodiment includes an information collection part 201, an analysis part 202, and a handling part 203. Each of these parts is realized, for example, by one or more programs installed in the monitoring device 10 causing the processor 108 or the like to perform the process. Furthermore, the monitoring device 10 according to the embodiment includes a database 204. The database 204 can be realized using, for example, the auxiliary storage device 107.

The information collection part 201 regularly or irregularly collects each collection information (EV collection information, EVSE collection information, reservation service collection information, building collection information, power grid collection information). Furthermore, the information collection part 201 stores each of these pieces of collection information in the database 204.

The analysis part 202 performs various analyzes using the collection information stored in the database 204 (or the collection information collected using the information collection part 201) to detect the occurrence of an abnormality in each entity.

When the occurrence of an abnormality is detected using the analysis part 202, the handling part 203 performs various controls, notifications, or the like to deal with the abnormality.

### Flow of Monitoring Process

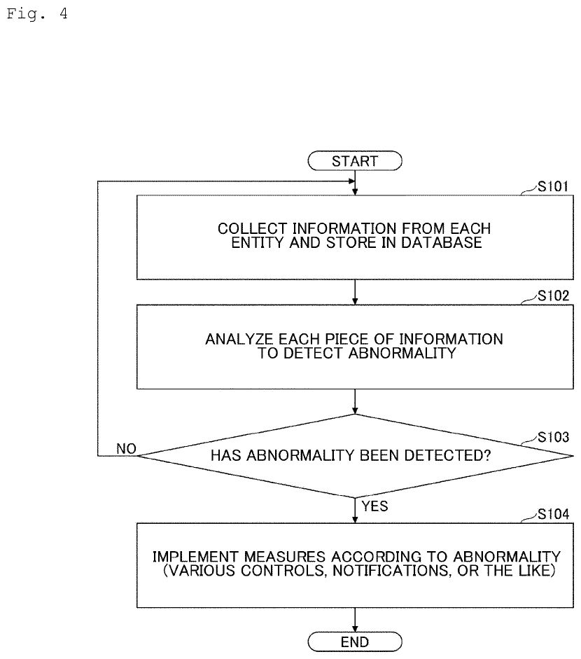

The flow of the monitoring processing according to the embodiment will be explained with reference to FIG. 4.

The information collection part 201 regularly or irregularly collects each collection information (EV collection information, EVSE collection information, reservation service collection information, building collection information, power grid collection information) and stores each piece of collection information in the database 204 (Step S101).

Subsequently, the analysis part 202 performs various analyzes using the collection information stored in the database 204 (or the collection information collected using the information collection part 201) to detect the occurrence of an abnormality in each entity (Step S102).

Here, the analysis part 202 detects the occurrence of an abnormality in each entity by, for example, performing cross-domain analysis using analysis scenarios and algorithms (including algorithms based on techniques such as machine learning and artificial intelligence) written in advance. An example will be explained below.

### Analysis Example 1

When the amount of power distributed to the EVSE increases even though the EVSE is not supplying power to the EV with reference to the usage information (amount of power supplied to EVs and date and time thereof) of EVSE collection information and the power distribution state (amount of power distributed to EVSE) of power grid collection information, an abnormality is detected as a possibility of power theft from that EVSE.

### Analysis Example 2

The distance from the EV of that vehicle ID to the EVSE of that charger ID is calculated with reference to the vehicle ID and the location information of the EV collection information, the charger ID and the reservation date and time of the reservation service collection information which includes the vehicle ID and the location information of the EVSE collection information which includes the charger ID. When the distance exceeds the distance in which the vehicle can reasonably move (for example, when it exceeds a predetermined threshold value or the like), the occurrence of an abnormality is detected as an invalid reservation.

### Analysis Example 3

When the EVSE of that charger ID cannot supply power with reference to the charger ID included in the reservation service collection information and whether power can be supplied in the EVSE collection information which includes the charger ID, the occurrence of an abnormality is detected as a reservation that cannot be fulfilled.

### Analysis Example 4

When the reserved power supply amount/power supply time exceeds the EVSE power supply amount/power supply time available for that charger ID with reference to the charger ID and the power supply amount/power supply time included in the reservation service collection information and the power suppliable amount/power suppliable time of the EVSE collection information which includes the charger ID, the occurrence of an abnormality is detected as the reservation cannot be fulfilled.

### Analysis Example 5

When there are a large number of reservations from the same user ID within a predetermined period of time (for example, when the number of reservations exceeds a predetermined threshold value) with reference to the reservation service collection information, the occurrence of an abnormality is detected as a denial of service (Dos) attack or an unauthorized reservation.

### Analysis Example 6

When there are a large number of reservations from the same charger ID within a predetermined time period (for example, when the number of reservations exceeds a predetermined threshold value) with reference to the reservation service collection information, the occurrence of abnormalities as being distributed denial of service (DDoS) attacks or fraudulent reservations are detected.

### Analysis Example 7

When there are times at which the amount of power distributed from the power grid to each EVSE exceeds the power capacity (upper limit of power amount) with reference to the charger ID, the reservation date and time, and the power supply amount in the reservation service collection information and the power capacity in the power grid collection information, the occurrence of an abnormality is detected as the amount of power which can be supplied being exceeded.

### Analysis Example 8

When certain EV collection information is collected from an EV which has been attacked in some way with reference to the information obtained from a vehicle security operation center (VSOC), the occurrence of an abnormality is detected as the EV collection information is invalid collection information.

### Analysis Example 9

When there is a large discrepancy with past performance values (for example, when there is a discrepancy with past performance values by a predetermined threshold value or more) with reference to the future required power consumption included in the building collection information, the occurrence of an abnormality is detected as an incorrect prediction performed as future required power consumption.

Note that the analysis examples 1 to 9 are all examples and it goes without saying that the analysis is not limited to the above as long as it is possible to detect the occurrence of any abnormality, besides these. For example, when the state of the EVSE collection information indicates that power cannot be supplied, the EVSE corresponding to the EVSE collection information may be assumed to have failed and an abnormality may be detected. Similarly, when the EV collection information includes abnormality detection information detected using the intrusion detection system (IDS) installed in the EV, the occurrence of an abnormality may be detected as if some kind of attack was performed on the EV.

Subsequently, the handling part 203 determines whether the occurrence of an abnormality has been detected in Step S102 described above (Step S103). Note that, when the occurrence of an abnormality is detected in Step S102 above, the monitoring device 10 proceeds to Step S104. On the other hand, when the abnormality is not detected in Step S102 above, the monitoring device 10 returns to Step S101 above.

The handling part 203 performs various controls, notifications or the like to each entity in response to the abnormality detected in Step S102 above to deal with the abnormality (Step S104).

Here, various types of control and notification can be considered and examples of control for the EV include automatic driving control, charging stop control, firmware update instruction, and the like. In addition, examples of notifications to the EV include notifications to the EV owner (notifications to an application, email notifications, notifications by a warning light provided in the EV or the like).

Examples of control over the EVSE include charging stop control and communication cutoff control with the EV. Examples of notifications to EVSE include notifications to operators of service providers which provide charging services using EVSE.

Examples of controls for the EVSE reservation application/reservation management server include reservation rejection control, reservation change control, and the like. Examples of notifications to the EVSE reservation application/reservation management server include notifications to users of the EVSE reservation application.

Examples of control over buildings include control to stop power supply to EVSEs installed on the same premises as the building. Examples of notifications to buildings include notifications to building managers.

Examples of control over the power grid include power distribution control (for example, control of safety devices and the like). Furthermore, examples of notifications to the power grid include notifications to operators who monitor the power grid and the like.

Note that the various controls and notifications described above are merely examples and it goes without saying that various controls and notifications may be performed in addition to these.

An example of control/notification when an abnormality occurrence is detected in each of the analysis examples described in Step S102 above is shown below.

### When an Abnormality is Detected in Analysis Example 1

In this case, for example, it is conceivable to notify the operator of a service provider which provides charging services using EVSE that there is a possibility of power theft. Thus, the operator can investigate in more detail whether power has been stolen and can take measures such as identifying the power thief and implementing measures to prevent power theft.

### When an Abnormality is Detected in Analysis Example 2

In this case, it is conceivable to perform reservation rejection control and notify the user that the reservation has been rejected because it is an invalid reservation, Thus, unauthorized reservations to EVSE can be prevented.

### When an Abnormality is Detected in Analysis Example 3 or Analysis Example 4

In this case, it is conceivable to perform reservation change control or rejection control and to notify the user that the user is encouraged to change to a reservation for power supply using another EVSE (or that the change has been made). Thus, it is possible to prevent reservations in which desired power supply is not possible.

### When an Abnormality is Detected in Analysis Example 5 or Analysis Example 6

In this case, it is conceivable to perform reservation rejection control. Thus, it is possible to prevent charging services from being stopped due to attacks such as DoS and DDoS. Note that, in addition to this, the power demand of the EVSE may be controlled to be lowered using a power control protocol (for example, a power control protocol such as OpenADR).

### When an Abnormality is Detected in Analysis Example 7

In this case, it is conceivable to perform reservation change control or rejection control and to notify the user that the user is encouraged to change to a reservation for power supply using another EVSE (or that the change has been made). Furthermore, an operator or the like who monitors the power grid may be notified that the power capacity may be exceeded. Thus, it becomes possible to prevent situations in which the power capacity of the power grid is exceeded or to temporarily increase the power capacity in some way.

### When an Abnormality is Detected in Analysis Example 8

In this case, it may be possible to control the EV by instructing it to update the firmware of the EV which has been attacked in some way. Thus, EV security can be improved. Note that, in addition to this, for example, the EV collection information collected from EVs that have been attacked in some way may be controlled so that it is not used for power supply and demand control services or the operator or the like may be notified that the collected EV information will not be used for power supply and demand control services. Thus, it is possible to prevent the EV collection information of EVs which have been attacked in some way from being used in power supply and demand control services.

### When an Abnormality is Detected in Analysis Example 9

In this case, for example, control can be conceived in which EV charging is stopped in buildings where incorrect predictions were made, or when the EV has a self-driving function, the EV headed for that building will be directed to another building. Thus, it is possible to prevent EVs from illegally supplying power to buildings for which incorrect predictions have been made. Note that, in addition to this, for example, the building manager may be notified that an incorrect prediction is being made.

Note that it goes without saying that the above analysis example and the control/notification content when an abnormality is detected based on the analysis example are merely examples and are not limited thereto. For example, when a reservation is made for a malfunctioning EVSE, the reservation may be controlled to be rejected or controlled to be changed or the user who made the reservation may be notified of the rejection/change. Furthermore, an EV in which an abnormality is detected using an in-vehicle IDS or the like may be instructed to update its firmware or may be controlled not to be used for power supply and demand control services.

### Conclusion

As described above, the monitoring device 10 according to the embodiment can regularly or irregularly monitor whether an abnormality has occurred in the components of the electric power supply and demand control service which utilizes EVs, and if an abnormality is detected, takes action to deal with the abnormality. Thus, it is possible to reduce the impact on the continuity of the power supply and demand control service due to the abnormality and it is expected that the continuity of the service will be guaranteed.

The present invention is not limited to the above-described specifically disclosed embodiments and various modifications and changes, combinations with known techniques, and the like are possible without departing from the scope of the claims.

### REFERENCE SIGNS LIST

10 Monitoring device
101 Input device
102 Display device
103 External I/F
103a Recording medium
104 Communication I/F
105 RAM
106 ROM
107 Auxiliary storage device
108 Processor
109 Bus
201 Information collection part
202 Analysis part
203 Handling part
204 Database

1. A monitoring apparatus comprising:
circuitry configured to
collect information from each entity that constitutes a power supply and demand control service using an electric transportation device;
detect occurrence of an abnormality in the entity through a predetermined analysis using the information; and
perform a control or a notification to deal with the abnormality upon occurrence of a condition in which the occurrence of the abnormality is detected.

2. The monitoring apparatus according to claim 1, wherein, in addition to the electric transportation device, the entity includes at least one of a charger for the electric transportation device, an electricity demand device to be a destination of power stored in the electric transportation device, a power grid that supplies grid power to the charger, an application that realizes a reservation service for the charger, or a server.

3. The monitoring apparatus device according to claim 1, wherein the circuitry is configured to detect the occurrence of the abnormality using cross-domain analysis that is performed based on an analysis scenario or an algorithm, the detecting being performed based on the information.

4. The monitoring apparatus according to claim 1, wherein the abnormality includes a failure of the entity, a request for processing or an operation that the entity is unable to perform, and a cyber attack against the entity.

5. The monitoring apparatus according to claim 4, wherein the request, for the processing or the operation that the entity is unable to perform, includes a request for a charger for the electric transportation device to be unable to supply power to the electric transportation device.

6. A monitoring method executed by a computer. comprising:
collecting information from each entity that constitutes a power supply and demand control service using an electric transportation device;
detecting occurrence of an abnormality in the entity through a predetermined analysis using the information; and
performing a control or a notification controlling or notifying to deal with the abnormality upon occurrence of a condition in which the occurrence of the abnormality is detected.

7. A non-transitory computer readable medium storing a program causing a computer to execute the monitoring method of claim 6.
